(19) United States
(12) Patent Application Publication
(10) Pub. No.: US 2016/0176062 A1
(43) Pub. Date: Jun. 23, 2016

(54) Slitting Machine

(71) Applicant: Dienes Corporation USA, Spencer, MA (US)

(72) Inventor: CHARLIE COMEAU, Brimfield, MA (US)

(21) Appl. No.: 14/925,815

(22) Filed: Oct. 28, 2015

Related U.S. Application Data
(63) Continuation of application No. 13/843,999, filed on Mar. 15, 2013, now abandoned.

(51) Int. Cl. B26D 7/26

(52) U.S. Cl. CPC B26D 7/2635

(57) ABSTRACT

A slitting machine comprising at least two knife holders, each of which has a respective knife rotatably mounted thereon; individually activatable electromagnets disposed on the knife holders; a single magnetostrictive rod, wherein all of said electromagnets are disposed along a length of the single rod, and wherein the electromagnets are adapted to be spaced as close as 0.5 inch from one another; and means for processing an interrogation by the magnetostrictive rod of activated ones of the electromagnets, and for indicating the position of at least one of the knife holders relative to the rod.

The present application is a continuation-in-part of U.S. application Ser. No. 13/843,999, wherein the invention relates to a slitting machine, in particular a slitting machine that is capable of indicating the position of at least one of its knife holders.

### BACKGROUND OF THE INVENTION

Slitting machines, such as those manufactured by the Dienes Corporation, are created to provide material manufacturers who typically use wide “webs” of raw material an ability to slit (cut) the wide material into narrower strips. The wide webs of material can be any width—from 36 inches to well over 300 inches. In order to accomplish this, slitting machines employ knife holder assemblies. Knife holder assemblies have a wide range of design variations but they all have one basic element—that being a cutting knife. The knife may be a sharp razor blade, it may be a sharp circular blade, or it may be a heated knife element.

Multiple knife holder assemblies have been used on individual slitting machines for decades across a broad variety of applications where a wide web of material (be it metal, paper, plastic, foil, carpet, fiberglass, rubber, roofing, etc) needs to be processed into narrower strips of material. These multiple knife holder assemblies always need to be re-positioned in response to the varying production demands that an individual material processor encounters on a daily basis.

The knife holder assemblies have traditionally been positioned by a variety of means:
1) Manually (by hand) where the relative spacing between knife holder assemblies is governed by precision machined spacing collars, spacer disks, fixtures, or the like—or by measuring devices (such as tape measures). The manual positioning of individual knife holder assemblies is a very tedious and time consuming process. The accuracy of manually positioning knife holder assemblies depends largely upon the skill of the person performing the job.
2) Semi-automatically by having an operator control powered movement devices on each knife holder assembly. The operator would typically be viewing a position display or digital readout while controlling the powered movement device in order to move the knife holder assembly to the desired position. While this is faster than manually positioning knife holder assemblies, it is still subject to being influenced by operator skill level and is not optimal.
3) Automatically by electric powered linear actuators that move each knife holder assembly to a predetermined position defined by a machine operator through an operator screen (HMI) and programmable logic controller (also known as a digital computer or a PLC or a programmable controller). The automatic placement of knife holder assemblies via linear actuators—while removing operator skill from the equation, still is a time consuming process as each knife holder assembly is moved individually to the desired location.

Slitting machines such as those made by the Dienes Corporation can employ anywhere from two to over one hundred knife holder assemblies that need to be re-positioned depending upon the material processors production schedule needs of that day. Re-positioning of these knife holder assemblies must be done efficiently and accurately.

One of the most current technologies for positioning systems employs magnetostrictive-based sensor rods. These rods work by inducing a sonic strain pulse in a specially designed magnetostrictive waveguide by the momentary interaction of two magnetic fields. One field comes from a movable permanent magnet which passes along the outside of the sensor tube, the other field comes from a current pulse or interrogation pulse applied along the waveguide. This interaction produces a strain pulse, which travels at sonic speed along the waveguide until the pulse is detected at the sensor head of the magnetostrictive rod. The magnets position on the rod is determined with high precision and speed by utilizing a high speed counter to accurately measure the elapsed time between the application of the interrogation pulse and the arrival of the resulting strain pulse. The elapsed time measurement is directly proportional to the position of the permanent magnet and is an absolute value. Therefore, the sensor's output signal corresponds to absolute position, instead of incremental, and never requires recalibration. Absolute, non-contact position sensing is achieved with absolutely no wear to the sensing components.

Slitting machines utilizing magnetostrictive rods would typically be designed to have one permanent magnet (either “C”-shaped or “U”-shaped or ring shaped) mounted onto each knife holder assembly that requires positioning. The permanent magnet is mounted on each knife holder assembly in such a way that it passes along the outside of the sensor tube of the magnetostrictive rod as the knife holder assembly is moved. The knife holder assemblies typically contain linear bearings (one or more) that are situated as to allow for sliding of the knife holder assembly along a linear rail (or rails). The linear rails are typically located on a structural member (a beam) of the slitting machine. As the magnetostrictive rod is also mounted on the beam in a manner parallel to the length of the linear rails, when the knife holder assembly is slid along the linear rails, the magnet is also slid along the length of the sensor tube on the magnetostrictive rod. The beam spans beyond the width of the wide web of material (that is to be slit into narrower strips) and is typically bolted to the sideframes of the slitting machine.

Positioning systems utilizing magnetostrictive rods (such as those manufactured by MTS Sensors, a division of MTS Systems Incorporated), has two severe limitations which are discussed in paragraphs [0009] and [0010] below.

The first limitation involves the fact that an individual magnetostrictive rod can have no more than 20-30 permanent magnets used on it at the same time. Each magnetostrictive rod is also tuned by the rod manufacturer, before shipment to the customer, for the number of permanent magnets to be used on it. Subtracting 3 or more permanent magnets on a rod that has been tuned for a specific quantity will result in widely fluctuating position readings and a lack of proper functionality. For customers who may want to add knife holder assemblies to an existing magnetostrictive rod on a slitting machine, the magnetostrictive rod must be removed from the machine and reprogrammed for the additional knife holder assemblies or it must be replaced by a new rod. As slitting machines produced by Dienes Corporation can easily require many more than 100 knife holder assemblies for a given application, this limitation of magnetostrictive rods causes the creation of slitting machine designs employing multiple rods (5 or more). These designs, while certainly functional, can be cost prohibitive along with being operationally problematic.

The second severe limitation of current magnetostrictive rod technology is that the relative closeness of two permanent magnetic fields on a single rod cannot be much less than 2 inches. (The claimed minimum spacing limit by magnetostrictive rod manufacturers is 3 inches but Dienes Corporation has successfully used rods in applications where the spacing is 2 inches). This 2 inch limitation presents a severe problem to slitting system manufacturers such as Dienes Corporation who have to closely position the knife holder assemblies to cut strip widths down to less than 0.5 inches. The current method of solving this second limitation is to again employ multiple magnetostrictive rods that are spaced a distance away from each other in order to allow the relative physical spacing of the knife holder assemblies to be less than 2 inches. Each knife holder assembly on the slitting machine would be designed to have the permanent magnet mounted in an alternating fashion (for example—high or low) over the appropriate magnetostrictive rod. In this manner, for instance, 10 knife holder assemblies could be mounted next to each other on a 1 inch spacing pattern where knife holder assembly 1 has a “low” magnet position to correspond with the first rod location, knife holder assembly 2 has a “high” magnet position to correspond with the second rod location, knife holder assembly 3 has a “low” magnet position and so on . . . . This design method keeps the spacing of each permanent magnet on a given rod at 2 inches but by using two separate rods, the individual knife holder assemblies can be spaced 1 inch apart. Again, these designs, while certainly functional, can be cost prohibitive along with creating many design difficulties.

Position specifications requiring 0.50″ or even less between magnets simply cannot be done practically with existing functional limits of magnetostrictive rods.

Since there is no commercially available solution to the two mentioned limitations of currently available magnetostrictive rods using permanent magnets, in order to move beyond these two impediments, Dienes Corporation engineers had to create a position sensing system along with uniquely crafted electromagnets that allow for the utilization of just one (1) magnetostrictive rod with anywhere from two to well over one hundred electromagnets that can be used on it.

### SUMMARY OF THE INVENTION

The electromagnets designed by Dienes Corporation had to allow for the generation of a magnetic field that was close to the magnetic field strength that exists in the currently utilized permanent magnets. The initial design requirements were that the electromagnet must be of a size no bigger than 0.4″×0.75″×1.25″ (currently utilized permanent magnets are larger than this). This small size was needed in order to meet the initial goal for placing knife holder assemblies at a then defined minimum spacing of 0.50 inches. Many, many electromagnet prototypes were created and tested before the design was proven. This unique electromagnet is mounted within the knife holder assembly and is “potted” within it in order to electrically insulate the magnet, to protect it from damage, and to cover it thereby preventing personnel from touching it.

The electromagnets created are each a two wire device that takes an electrical current and passes it through a wire that is wound around an alloy core. The alloy core is specially shaped to produce a south pole field in the “C” or “U” or ring shaped head of the core. Each electromagnet is individually activatable and the strength of the magnetic field created in the electromagnet is controlled by the input voltage provided through the wires surrounding the electromagnet core. The input voltage to the electromagnet can be provided via a DC power supply or via batteries.

Regarding the first functional impediment of sensing rods, as current magnetostrictive rod technology restricts the number of permanent magnetic fields (20-30) that can be present at one time on a given rod, the use of an electromagnet (which can be quickly powered on and off) provides capability for any number of said magnets to be used—as long as no more than (20-30) are powered at once. For example, think of a given automatic slitting system that needs to employ 100 knife holder assemblies to be spaced at a minimum of 0.5 inches apart. Each knife holder assembly needs to have an electromagnet mounted on it. The electromagnet on knife holder assemblies #1, 21, 41, 61, and 81 could be powered at the same time in order to have their positions sensed by the magnetostrictive rod. These five electromagnets are then turned off and the magnets on knife holder #2, 22, 42, 62, and 82 are powered on so as to have their positions sensed by the magnetostrictive rod. These five electromagnets are then turned off and the magnets on knife holder #3, 23, 43, 63, and 83 are powered on so as to have their positions sensed by the magnetostrictive rod and so on until all one hundred positions have been recorded. This method of powering on “groups” or “banks” of electromagnets solves one of the problems with existing magnetostrictive rods—i.e. the 20-30 permanent magnet maximum limit on an individual rod. Sensing the position of each knife holder assembly in a given bank takes less than a second. Once all of the positions are sensed by the rod and the values are captured by the programmable logic controller (or PLC or digital computer or programmable controller) all 100 knife holder assemblies will automatically move to the newly defined positions as defined by the operator within the machine control. The above described method of powering on 5 electromagnets at a time could be also be done by powering on pairs of magnets or ten magnets or fifteen magnets at a time. Selection of how many electromagnets are to be powered on at a given time depends upon the number of knife head assemblies on a given slitting machine. This Dienes design allows for an unlimited number of electromagnets to be used on a single magnetostrictive rod.

Secondly, as explained above, since the Dienes electromagnet design can be turned on and off (either individually or in groups or banks), the 2 inch limitation is capable of being totally bypassed. For example, if we have a slitting requirement for 10 cuts and all of the knife holder assemblies have to be spaced to achieve 0.75″ slits, we would need to power on knife holder assembly #1 and #5 (which corresponds to a 3.0″ space between those two electromagnets) at the same time in order to have their positions sensed by the magnetostrictive rod. These two electromagnets are then turned off and the magnets on knife holder #2 and 6 (another 3.0″ space between electromagnets) are powered in order to have their positions sensed by the magnetostrictive rod and so on until all ten knife holder assembly positions have been recorded. This Dienes design therefore allows for the placement and use of electromagnets that are much less than 2.0″ apart without resulting in widely fluctuating position readings and lack of proper functionality.

The Dienes electromagnet design is capable of being used for position sensing systems on a wide range of equipment that can utilize a single magnetostrictive rod where those systems have a need for determining the position of multiple components if said multiple components are required to be spaced less than two inches apart or if it is required to use more than 20-30 permanent magnets on a single magnetostrictive rod.

Further specific features of the present invention will be described in detail subsequently.

### BRIEF DESCRIPTION OF THE DRAWINGS

The objects and advantages of the present invention will appear more clearly from the following specification in conjunction with the accompanying schematic drawings, in which:

FIG. 1 is a side view of one exemplary embodiment of a slitting machine of the present application, showing a representative knife holder and electromagnet along with an associated magnetostrictive rod;

FIG. 2 shows a side view and front view of one exemplary embodiment of an electromagnet sensor for the slitting machine of FIG. 1; and

FIG. 3: shows a comparison between the limited number of knives/sensors possible with prior art devices and the essentially unlimited number of knives and their electromagnets that are possible with the slitting machine of the present application.

### DESCRIPTION OF SPECIFIC EMBODIMENTS

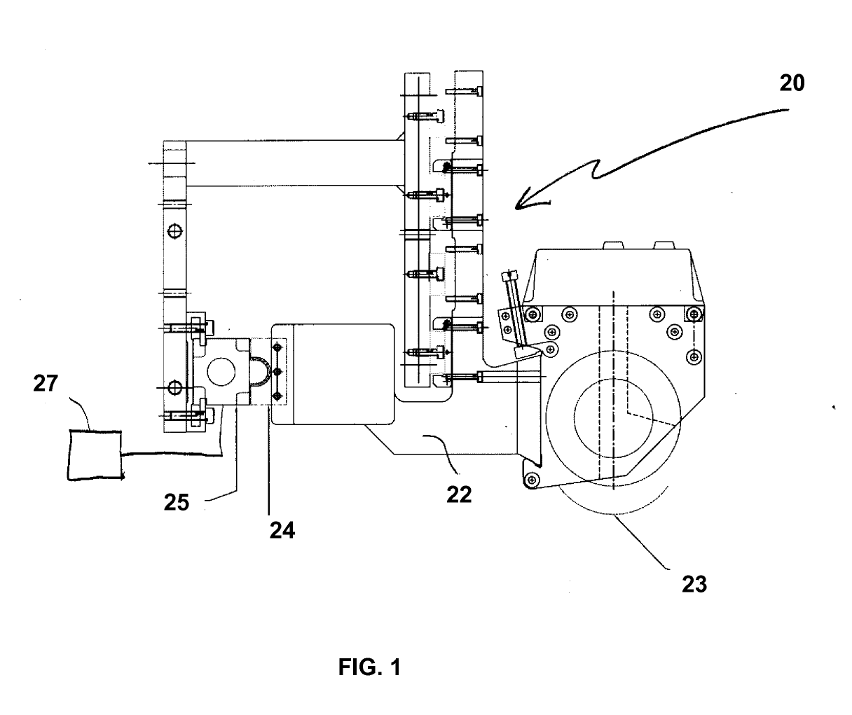

Referring now to the drawings in detail, the slitting machine of the present application is designated generally by the reference numeral 20 in FIG. 1, and includes a plurality of knife or blade holders 22, only one of which is visible in FIG. 1, the angle of viewing of which is parallel to the direction of displacement of the knife holders 22. Associated with each knife holder 22 is a blade or knife 23 that is rotatably mounted on the knife holder, an electromagnet 24 as a sensor that is fixedly mounted on the knife holder, a single magnetostrictive rod 25, and means 27, such as a computer, for processing an interrogation by the magnetostrictive rod 25 of the electromagnet sensor 24.

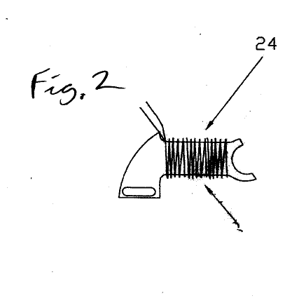

The electromagnets sensors 24 have a C or U shaped portion (see FIG. 2) through which the single magnetostrictive rod 25 extends. The rod 25 is stationarily mounted, so that as the knife holders 22 are displaced, the electromagnets 24, which due to their fixed mounting on the knife holders 22 travel along with it, are correspondingly displaced along the length of the magnetorestrictive rod 25, which extends in a direction parallel to the direction of displacement of the knife holders 22. When one of the electromagnets 24 is activated, in other words when power is supplied to it, the electromagnet creates a magnetic field. This magnetic field can be sensed by the magnetostrictive rod 25, and the signal generated is conveyed from the magnetostrictive rod 25 to the computer or other means 27 for processing such an interrogation of the activated electromagnet 24. The means 27 can then provide feedback regarding, i.e. can indicate, the position of the electromagnet 24, and hence of the knife holder 22, relative to the magnetostrictive rod 25. In one exemplary embodiment, the electromagnet 24, made from a cold rolled steel blank, is wound with 28 ga mag wire (six passes). The blank has a thickness of, for example, 0.08 inches.

Thus, as the knife holders 22, along with their knives 23, are appropriately positioned for slitting by being displaced on a rail or cross beam, the electromagnets 24 are moved along with the knife holders 22 on which they are fixedly mounted. By activating a number of electromagnets 24 in a staggered, grouped or banked manner, not only can the position of the knife holders 22 relative to the magnetostrictive rod 25 be detected and indicated, but also the position of the knife holders 22 relative to one another can be indicated.

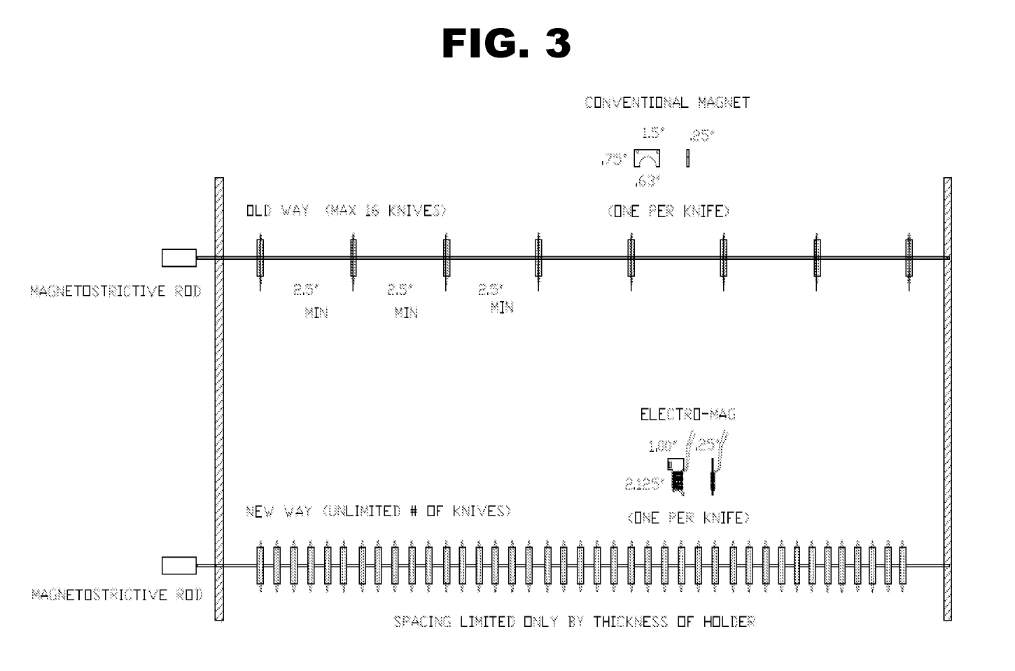

FIG. 3 schematically indicates how pursuant to the slitting machine of the present invention, the number of knife holders 22, and hence the number of associated electromagnets 24, that can be provided using only a single magnorestrictive rod 25 for the electromagnetic sensors, is limited only by the relatively narrow thickness or width of the knife holders 22, and of course the length of the rod 25. This for the first time possible, immediately adjacent to one another arrangement of the knife holders 22 is due to the fact that with the slitting machine of the present application, the electromagnets sensors 24 can be turned on and off in a staggered manner. The minimal spacing between adjacent knife holders 22 that can be achieved with the present invention provides for a far greater accuracy in determining the exact position of a given knife 23. For example, whereas with heretofore known devices, the permanent magnets provided on a single magnetostrictive rod had to be spaced at least two to two and a half inches apart, with the slitting machine of the present application the electromagnets 24 can be spaced one half inch or even less apart on a single magnetostrictive rod 25.

The present invention is, of course, in no way restricted to the specific disclosure of the specification and drawings, but also encompasses any modifications within the scope of the appended claims.

I claim:

1. A slitting machine, comprising:
at least two knife holders, each of which has a respective knife rotatably mounted thereon;
individually activatable electromagnets disposed on said knife holders;
a single magnetostrictive rod, wherein said electromagnets are adapted to be spaced as close as 0.5 inch from one another; and
means for processing an interrogation by said magnetostrictive rod of activated ones of said electromagnets, and for indicating the position of at least one of said knife holders relative to said rod.

2. A slitting machine according to claim 1, wherein each of said electromagnets has a C or U shaped portion that extends about said magnetostrictive rod.

3. A slitting machine according to claim 1, wherein said electromagnets are activatable in groups.

4. A slitting machine according to claim 1, which includes an unlimited number of said electromagnets.

5. A slitting machine according to claim 4, which includes t least 100 of said electromagnets.

6. A method of operating the slitting machine of claim 1, including the steps of:
activating said electromagnets such that there is a spacing of at least 2 inches between activated ones of said electromagnets.

7. The method of claim 6, which includes the further steps of providing a plurality of said electromagnets and activating said electromagnets in groups.

8. The method of claim 7, which includes providing an unlimited number of said electromagnets.

9. The method of claim 8, which includes providing at least 100 of said electromagnets.
